(19) United States
(12) Patent Application Publication
(10) Pub. No.: US 2023/0229856 A1
(43) Pub. Date: Jul. 20, 2023

(54) SYSTEMS AND METHODS FOR CREATING AND USING CONDITIONAL PARAMETERS TO CUSTOMIZE PRESENTATIONS

(71) Applicant: ADVISR, Inc., New York, NY (US)

(72) Inventors: Stephen Renz, New York, NY (US); Ryan Osborn, New York, NY (US); Lauren Lamonica Rosenthal, Walnut Creek, CA (US); Jesse Lee Rohland, New York, NY (US)

(21) Appl. No.: 18/096,211

(22) Filed: Jan. 12, 2023

Related U.S. Application Data
(60) Provisional application No. 63/300,859, filed on Jan. 19, 2022.

(51) Int. Cl. G06F 40/186

(52) U.S. Cl. CPC G06F 40/186

(57) ABSTRACT

Methods and supporting systems for generating customized presentations include obtaining a presentation template comprising a specific slide that permits conditional elements (and in some cases can therefore be customizable), generating a conditional slide by assigning a slide condition to the specific slide, and generating the customized presentation that includes the conditional slide.

### CROSS REFERENCE TO RELATED APPLICATIONS

This application claims the benefit of and priority to U.S. Provisional Patent Application No. 63/300,859, filed on Jan. 19, 2022. The foregoing application is incorporated by reference herein in its entirety and for all purposes.

### FIELD OF THE INVENTION

The subject matter of this application relates generally to techniques for creating customizable electronic presentations, and, more specifically, to creating or generating parameterized templates and presentations as conditions in a custom presentation.

### BACKGROUND

Presentation creation tools that are currently known include Microsoft PowerPoint, Google Slides and/or Keynote. In current presentation technologies, a user may need to manually copy and update presentation templates to accommodate the company presenter groups (e.g., local sellers) and topics. For example, if a user needs to create presentations for three different topics for each of five customers, the user may need to create 5×3=15 different presentations for each of the customer and topic combinations. Moreover, to accommodate each customer, the user may need to use five different customer logos. For each customer, the user may then need to create a customized slide for each of the three topics for each presentation, which is not relevant to other topics of other two presentations.

Conventional presentation technologies do not include a feature to enable adding slides conditionally. Further, the need to create customized presentation slides can be time consuming, requiring hours of manually copying and updating graphics to make and maintain the many different presentations, and can lead to errors.

Thus, customizable presentation creation tools that can improve a user's efficiency are needed.

### SUMMARY

Disclosed herein are methods and systems for creating and using conditional parameters to customize presentations. Generally, the methods and systems disclosed herein enable creating and using of parameter-driven, conditional templates for a user to create one presentation template that is customizable or adjustable for a variety of presentation conditions (e.g., the presenter, client (or customer), group, time, date, location, audience, topics, and other suitable metadata related to the presentation and/or users (e.g., the presenter, client, audience, and/or admin user)).

Advantageously, the methods and systems disclosed herein can improve a user's efficiency and performance of creating and using presentation slides. For example, by using parameter-based slide conditions as disclosed herein, a presentation template can be generated for implementing a variety of different conditions or scenarios, resulting in a reduced number of presentations to be used or maintained, as well as reduced time and work needed.

In one aspect, a method for generating a customized presentation includes obtaining a presentation template comprising a specific slide that permits conditional elements (and in some cases can therefore be customizable), generating a conditional slide by assigning a slide condition to the specific slide, and generating the customized presentation that includes the conditional slide.

In some embodiments, the presentation template may include a universal slide representing general information for the customized presentation, which may include a title, an agenda, a salutation, (e.g., “thank you”), or any combinations thereof. The specific slide may represent a specific condition of the customized presentation such as a specific presenter, client, group, time, date, location, audience, topics, admin user, or combinations thereof. In some embodiments, the slide condition is evaluated based on a set of presentation metadata such as a presentation creator, one or more presenters, an intended audience, and one or more topics.

In another aspect, a system for generating a customized presentation includes one or more processors and a memory coupled with the one or more processors, wherein the processor executes a set of stored computer instructions, that when executed: obtain a presentation template comprising a specific slide that permits conditional elements (and in some cases can therefore be customizable), generate a conditional slide by assigning a slide condition to the specific slide, and generate the customized presentation that includes the conditional slide.

In some embodiments, the presentation template may include a universal slide representing general information for the customized presentation, which may include a title, an agenda, a salutation, (e.g., “thank you”), or any combinations thereof. The specific slide may represent a specific condition of the customized presentation such as a specific presenter, client, group, time, date, location, audience, topics, admin user, or combinations thereof. In some embodiments, the slide condition is evaluated based on a set of presentation metadata such as a presentation creator, one or more presenters, an intended audience, and one or more topics.

### BRIEF DESCRIPTION OF THE DRAWINGS

These and other features, aspects, and advantages of the present invention will become better understood with regard to the following description, and accompanying drawings, where:

FIG. 1A illustrates an example chart in generating presentations.

FIG. 1B illustrates a chart in generating presentations using the systems and methods, in accordance with some embodiments, as describe herein.

FIGS. 2A-2E illustrate flowcharts of creating one or more conditional slides in a presentation template, and generating a specific presentation using the one or more conditional slides, in accordance with some embodiments, as describe herein.

FIGS. 3-6 illustrate data structures and data types that can be used as slide conditions or parameters to drive the conditional elements of the presentation and slides as described in FIGS. 1-2.

FIG. 7 depicts an example computing device for implementing system and methods described in FIGS. 1-6.

### DETAILED DESCRIPTION

As described herein, the disclosed embodiments of this application include techniques, methods, and systems for generating presentations. In some embodiments, the techniques, methods, and systems include generating customized presentations by using conditional parameters.

As described herein, “conditional parameters,” “conditions,” “specific conditions,” “particular conditions,” or “slide conditions” refer to attributes and/or parameters that are related to a presentation or to specific slides within a presentation template for automatically showing or hiding slides or slide elements within a presentation. In some embodiments, a specific condition or slide condition includes information of a presenter (e.g., name of a presenter), a client (or customer), group, time, date, location, audience, topics, and other suitable information related to the presentation and/or users (e.g., the presenter, client, audience, and/or admin user). In some embodiments, a slide condition can be based on system metadata of the presentation such as the presentation creator, presentation audience, and/or presentation topic. For example, if the conditions are met by the metadata in a presentation, a specific slide and/or slide element may be inserted in the presentation. In some cases, a slide or slide element may be removed based on meeting or not meeting a condition, or, in other cases, moved from one slide (e.g., a table of contents) to another (e.g., an appendix slide). Metadata that may be used as parameters to meet particular conditions such as information of a presenter (e.g., name, role, location of a presenter), a client (or customer), group, time, date, location, audience, topics, and other suitable metadata related to the presentation and/or users (e.g., the presenter, client, audience, and/or admin user).

In comparison with a slide condition implemented within an add-on application (e.g., a PowerPoint add-on application) to hide or unhide slides based on a text in a presentation, the presently disclosed embodiments are configured to insert one or more slides (e.g., customized slides) into a presentation based on the metadata about the presentation. In some embodiments, customizing slides based on metadata for the presentation can be disabled.

A “conditioned slide,” “conditional slide,” “conditioned slide element,” or “conditional slide element” refers to a slide that includes one or more features that allows a user to insert one or more slides into a presentation template that helps generate presentations for various conditions or scenarios. In some cases, the conditions may be related to elements within a slide, such as text, characters (e.g., symbols), images, video, and/or audio. In some embodiments, a slide condition is based on presentation metadata. For example, a user with administrator permissions (e.g., an admin user) can set up a general presentation template and then add slide conditions to one or more slides to create one or more conditioned slides. Then, users with permission to use the presentation template can generate a presentation with the one or more conditional slides that are inserted or removed depending on the presentation metadata. During the generation of the presentation, an admin user may oversee the creation of the presentation template and/or provide guidance to administrate the presenter user(s).

Similarly, a user with administrator permissions (e.g., an admin user) can set up a general presentation template and then add slide conditions to one or more slide elements to create one or more conditioned slide elements. Then, users with permission to use the presentation template can generate a presentation with the one or more conditional slide elements that are inserted or removed depending on the presentation metadata. During the generation of the presentation, an admin user may oversee the creation of the presentation template and/or provide guidance to administrate the presenter user(s). For example, the admin user can add slide conditions to different logos within one or more slides of a general presentation template, where the different logos represent a variety of clients (or customers). Then, for each client, a presentation including the particular logo for the client and excluding logos for other clients can be generated, based on whether the metadata of the presentation meets the slide conditions (e.g., the name of the client) added to the one or more logos.

Advantageously, creating and/or using slide conditions to automatically effect the inclusion or exclusion of particular slides or slide elements reduces the number of presentations that an organization or a user needs to maintain. More specifically, the technique enables the use of a more general presentation template with slides and/or slide elements that are shown conditionally and providing slide conditions such as presentation metadata representing various scenarios (e.g., the presentation creator, the presentation audience, or presentation topic). As such, one presentation template can be used for creating or generating many presentations, reducing time compared with manually creating or maintaining a number of presentations targeted to the various scenarios (e.g., presenters, audiences, topics) that requires hours of editing such as copying presentations, and/or updating messaging, brand elements and/or details.

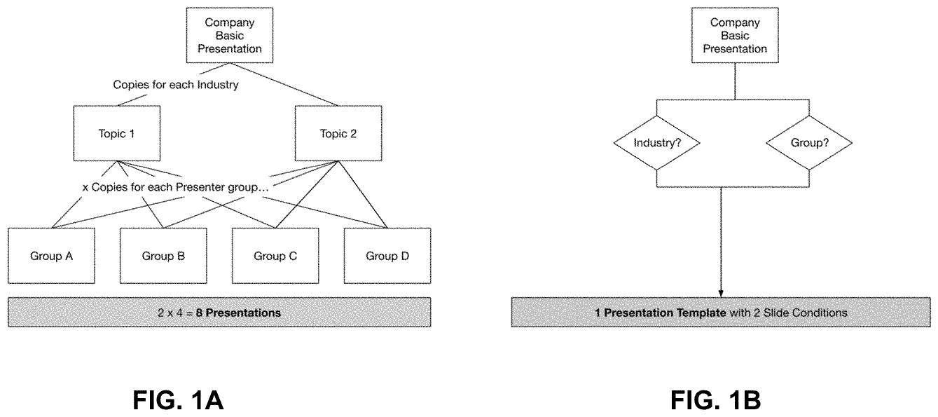

FIG. 1A illustrates an example chart in generating presentations, e.g., using conventional presentation creation techniques. FIG. 1B illustrates a chart in generating presentations using the systems and methods, in accordance with some embodiments as describe herein. As shown in FIGS. 1A and 1B, generating a presentation template by using slide conditions (FIG. 1B) may enable the presentation template to be a single source of multiple presentations each of which may be used for a variety of scenarios, resulting in reduced time (e.g., several hours) to prepare many presentations by updating elements such as brand elements, messaging and/or details (as required in FIG. 1A).

Generally, to generate one or more conditional slides for a presentation, a user may set presentation metadata in their system (e.g., a computer system), or in some cases the metadata may be captured from the system itself (such as location, language, licensing entity, etc.). The metadata can include possible presentation presenters, audiences and/or topics. Then, the user may create a presentation template including one or more slides and specific slide elements that can be either included or excluded when a user creates a particular presentation. For each slide (or certain slides) within the presentation template, the user may have the option to add one or more slide conditions. For example, to add a slide condition in a presentation template, the user selects “Add Condition” using a presentation setting (e.g., the menu provided on a slide), and provides the type of condition to be added and the value(s) of the condition that effect the inclusion or exclusion of the slide or slide element. Accordingly, any presentation generated from the presentation template and meets the condition criteria will include the conditional slide.

For example, if a user has a slide including the topic of “Increasing Your Revenue,” the user can generate a conditional slide by navigating the slide in a presentation template, adding the kind of condition to be added (e.g., a subcategory “Goal” in the condition of “Topic”), and then selecting “Increasing Revenue” from a list of values already set up as metadata in the database for the “Goal.” The user then saves the slide with the topic value (e.g., “Increasing Revenue”) as a condition. Moving forward, any presentation that the user may generate from that presentation template including presentation metadata that has the goal of “Increase Revenue” will include the “Increasing Your Revenue” slide.

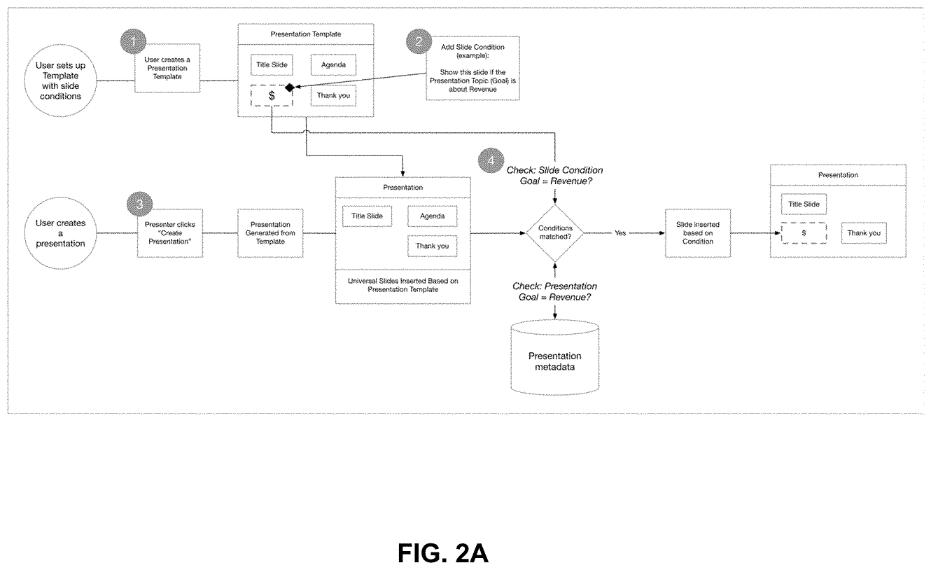

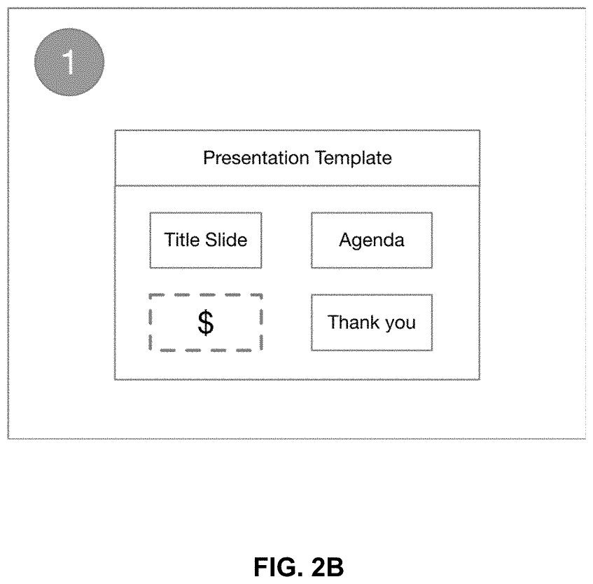

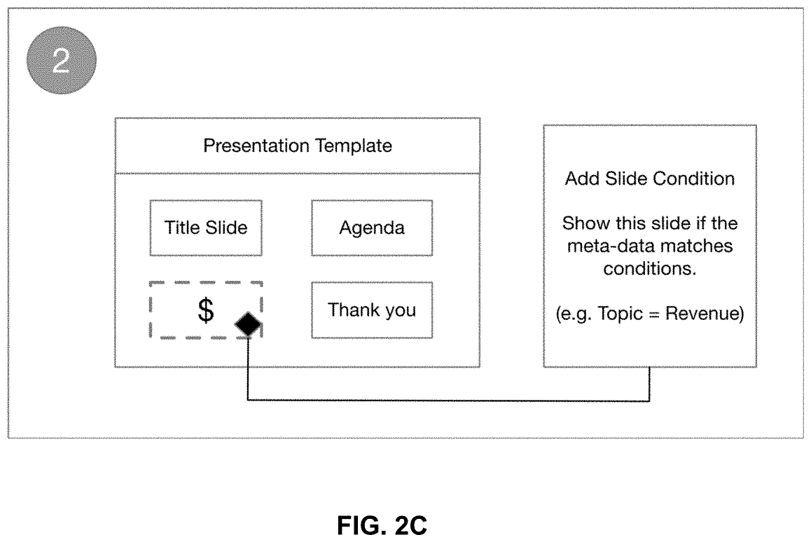

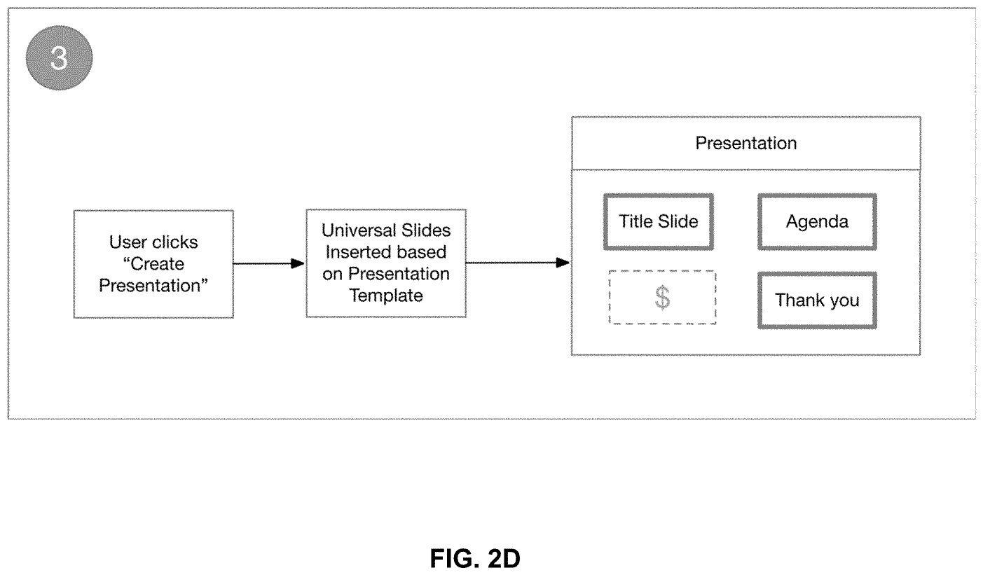

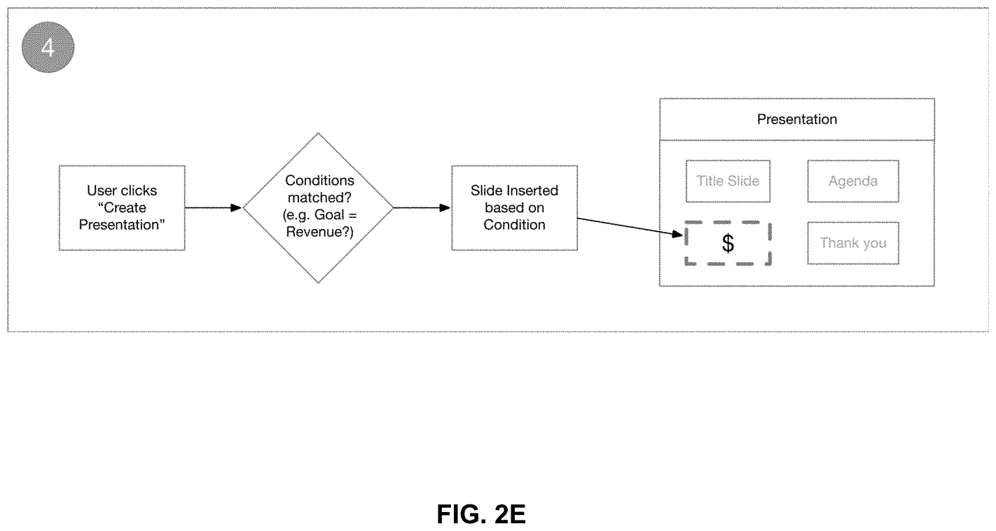

FIGS. 2A-2E illustrate flowcharts of creating one or more conditional slides in a presentation template, and generating a specific presentation using the one or more conditional slides. As shown in FIG. 2A, steps 1 and 2 include methods for creating one or more conditional slides in a presentation template, and steps 3 and 4 include methods for generating a specific presentation using the one or more conditional slides, as described in further detail below.

At step 1, as shown in FIG. 2B, a user creates a presentation template to include one or more universal slides (e.g. slides of title, agenda, salutation such as “thank you,” combinations thereof, or other general information for a presentation) and/or specific slides (e.g. a slide specific for a topic of revenue “$”).

As used herein, “a universal slide” refers to a slide that represents general information for a presentation, such as a thank you slide. In some embodiments, a universal slide is applicable in different conditions of a presentation, and is not necessary to be customized in different conditions. A “specific slide” refers to a slide that represent specific information (e.g., topic) included in the slide. In some embodiments, a specific slide is applicable for some specific condition (e.g., presenter, client (or customer), group, time, date, location, audience, topics, admin user, or other suitable conditions) of a presentation, and is not applicable in other conditions. In some embodiments, a specific slide is customizable (e.g., inserted, removed, and/or amended) based on the specific condition(s) that the specific slide is applicable for. For example, the specific slide can be inserted to a presentation that includes a specific topic that the specific slide is applicable for. In another example, the specific slide can be removed from a presentation that the specific slide is not applicable for. In another example, the specific slide can be amended to include the entire information in the specific slide (or a portion thereof) based on the specific conditions that the specific slide is applicable for.

At step 2, as shown in FIG. 2C, the user adds one or more slide conditions to a specific slide in the presentation template, so that the specific slide appears if certain meta-data conditions or criteria are met (e.g., if the topic of the presentation includes the topic of revenue).

At step 3, as shown in FIG. 2D, a presenter generates a specific presentation using the presentation template created at step 1 and the slide conditions created at step 2, by e.g., clicking “Create Presentation” tab in the system. Accordingly, the specific presentation includes universal slides (e.g. slides of title, agenda, salutation such as “thank you,” or other general information for a presentation) created in the presentation template.

At step 4, as shown in FIG. 2E, the system may automatically check whether the condition in a specific slide created at steps 1 and 2 match the condition or criteria of the specific presentation. For example, the system may obtain the metadata of the specific presentation, where the presenter provides the kind and the value of the condition for the specific presentation. The system may then check the criteria such as whether the metadata matches the condition (e.g. a topic of revenue “$”) of the conditional slide in the presentation template. If this criteria is met, then the system automatically inserts the slide in the presentation. If this criteria is not met, then the system automatically removes the specific slide in the presentation.

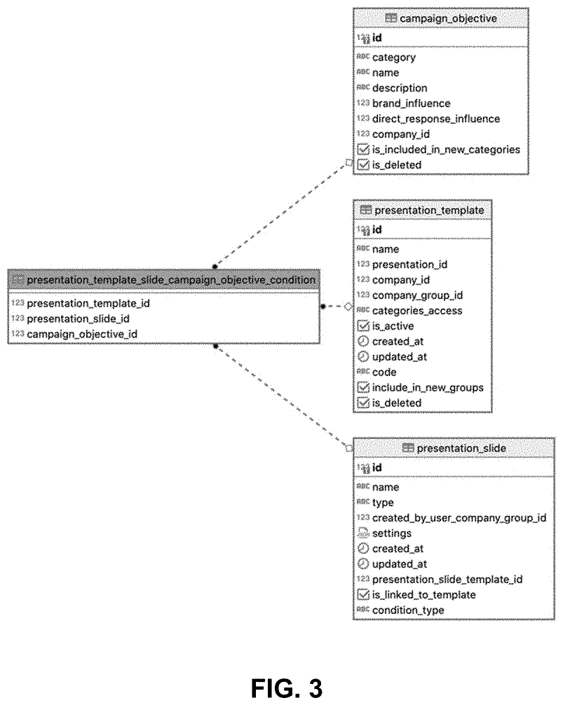

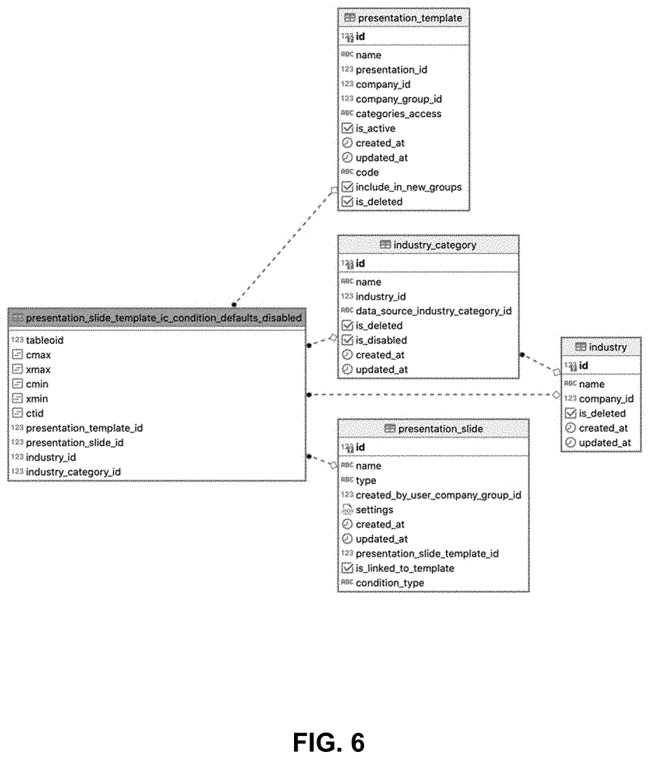

FIGS. 3-6 illustrate data structures and data types that can be used as slide conditions or parameters to drive the conditional elements of the presentation and slides as described in FIGS. 1-2.

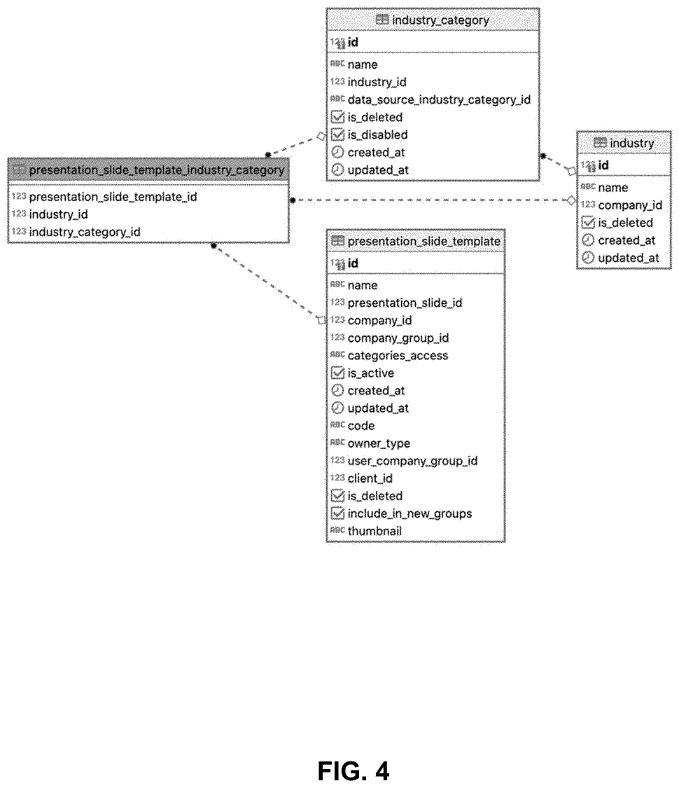

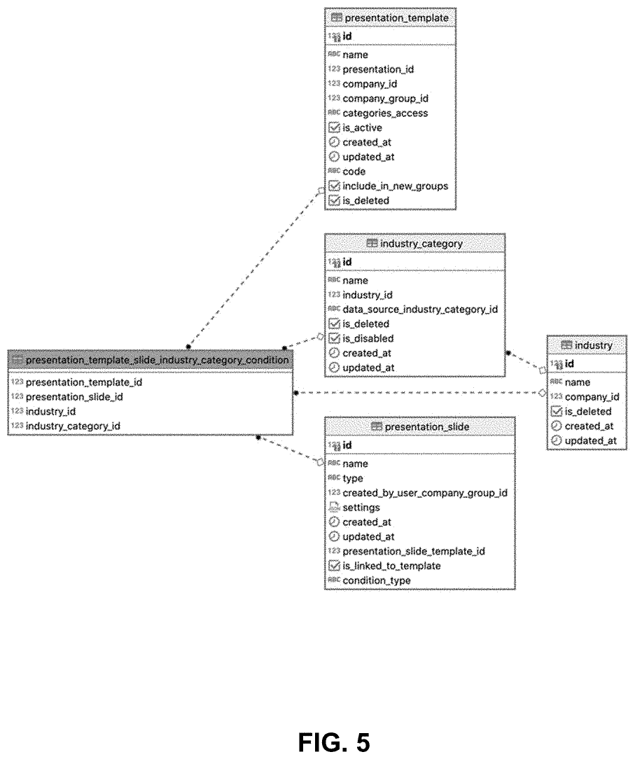

As shown in FIGS. 3-6, the slide conditions or parameters are customizable. In some embodiments, the slide conditions or parameters are selected from one or more data structures or data types in the categories of campaign objective, presentation template, industry category, presentation slide, and/or any other suitable categories and sub-categories. In some cases, a slide parameter in a subcategory (e.g., “industry” in FIGS. 4 and 5) is directly linked to and provided to a presentation template. In some cases, the parameters in a subcategory (e.g., “industry” subcategory in FIGS. 4 and 5) is provided to a presentation template via another category (e.g., “industry_category” in FIGS. 4 and 5), and is thus indirectly linked to the presentation template.

System and/or Computer Embodiments

Examples of a computing device can include a personal computer, desktop computer laptop, server computer, a computing node within a cluster, message processors, hand-held devices, multi-processor systems, microprocessor-based or programmable consumer electronics, network PCs, minicomputers, mainframe computers, mobile telephones, PDAs, tablets, pagers, routers, switches, and the like.

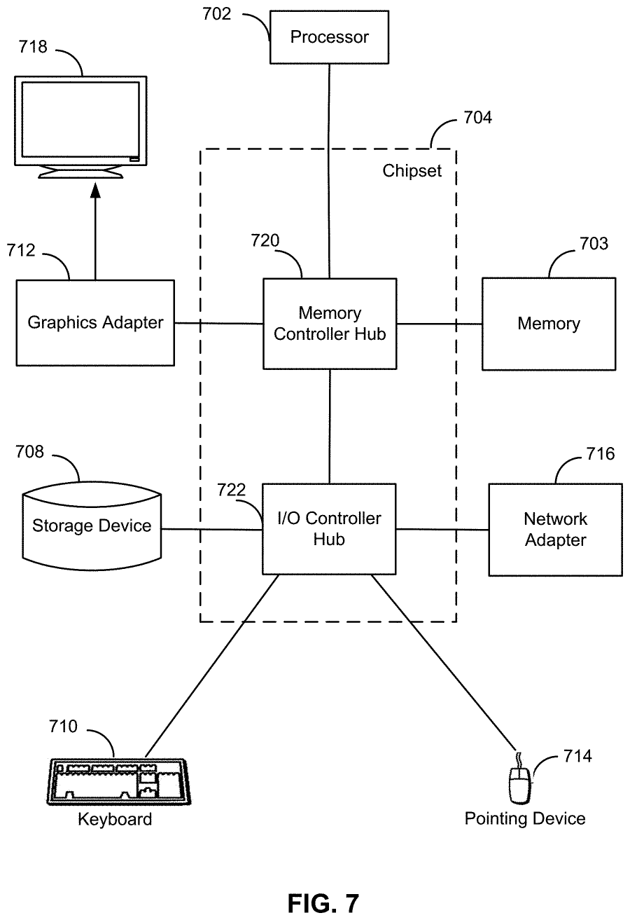

FIG. 7 illustrates an example computing device for implementing system and methods described in FIGS. 1-6. In some embodiments, the computing device includes at least one processor 702 coupled to a chipset 704. The chipset 704 includes a memory controller hub 720 and an input/output (I/O) controller hub 722. A memory 706 and a graphics adapter 712 are coupled to the memory controller hub 720, and a display 718 is coupled to the graphics adapter 712. A storage device 708, an input interface 714, and network adapter 716 are coupled to the I/O controller hub 722. Other embodiments of the computing device have different architectures.

The storage device 708 is a non-transitory computer-readable storage medium such as a hard drive, compact disk read-only memory (CD-ROM), DVD, or a solid-state memory device. The memory 706 holds instructions and data used by the processor 702. The input interface 714 is a touch-screen interface, a mouse, track ball, or other type of input interface, a keyboard, or some combination thereof, and is used to input data into the computing device. In some embodiments, the computing device may be configured to receive input (e.g., commands) from the input interface 714 via gestures from the user. The graphics adapter 712 displays images and other information on the display 718. The network adapter 716 couples the computing device to one or more computer networks.

The computing device is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 708, loaded into the memory 706, and executed by the processor 702.

The types of computing devices can vary from the embodiments described herein. For example, the computing device can lack some of the components described above, such as graphics adapters 712, input interface 714, and displays 718. In some embodiments, a computing device an include a processor 702 for executing instructions stored on a memory 706.

Embodiments of the invention can be implemented in digital electronic circuitry or in computer software, firmware, or hardware, including the structures disclosed in this specification and their structural equivalents, or in combinations of one or more of them. It can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. It is also available via mobile device. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

It should also be noted that the present implementations can be provided as one or more computer-readable programs embodied on or in one or more articles of manufacture. The article of manufacture can be any suitable hardware apparatus, such as, for example, a floppy disk, a hard disk, a CD-ROM, a CD-RW, a CD-R, a DVD-ROM, a DVD-RW, a DVD-R, a flash memory card, a PROM, a RAM, a ROM, or a magnetic tape. In general, the computer-readable programs can be implemented in any programming language. The software programs can be further translated into machine language or virtual machine instructions and stored in a program file in that form. The program file can then be stored on or in one or more of the articles of manufacture.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

For further description of illustrative embodiments along with further details and applications of the invention, refer to the following documents. It should be noted that all headings are only illustrative in nature and are not to be construed in any limiting sense.

Having thus described several aspects of at least one embodiment of this invention, it is to be appreciated that some alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

All references, issued patents and patent applications cited within the body of the specification are hereby incorporated by reference in their entirety, for all purposes.

1. A method for generating a customized presentation, comprising:
obtaining a presentation template comprising a specific slide comprising one or more conditional elements;
generating a conditional slide by assigning a condition to the one or more conditional elements of the specific slide; and
generating the customized presentation comprising the conditional slide.

2. The method of claim 1, wherein the presentation template further comprises a universal slide representing general information for the customized presentation.

3. The method of claim 2, wherein the universal slide comprises any one of title, agenda, salutation, or combinations thereof.

4. The method of claim 1, wherein the specific slide represents a specific condition of the customized presentation.

5. The method of claim 5, wherein the specific condition comprises a specific presenter, client, group, time, date, location, audience, topics, admin user, or combinations thereof.

6. The method of claim 1, wherein the specific slide is customizable.

7. The method of claim 1, wherein the condition is evaluated based on a set of presentation metadata.

8. The system of claim 7, wherein the metadata comprises at least one of a presentation creator, one or more presenters, an intended audience, and one or more topics.

9. A system for generating a customized presentation, comprising:
one or more processors; and
a memory coupled with the one or more processors, wherein the processor executes a set of stored computer instructions, that when executed:
obtain a presentation template comprising a specific slide comprising one or more conditional elements;
generate a conditional slide by assigning a condition to the one or more conditional elements of the specific slide; and
generate the customized presentation comprising the conditional slide.

10. The system of claim 9, wherein the presentation template further comprises a universal slide representing general information for the customized presentation.

11. The method of claim 10, wherein the universal slide comprises any one of title, agenda, salutation, or combinations thereof.

12. The method of claim 9, wherein the specific slide represents a specific condition of the customized presentation.

13. The method of claim 12, wherein the specific condition comprises a specific presenter, client, group, time, date, location, audience, topics, admin user, or combinations thereof.

14. The method of claim 9, wherein the specific slide is customizable.

15. The method of claim 9, wherein the condition is evaluated based on a set of presentation metadata.

16. The system of claim 15, wherein the metadata comprises at least one of a presentation creator, one or more presenters, an intended audience, and one or more topics.
